(19) United States
(12) Patent Application Publication
(10) Pub. No.: US 2023/0068582 A1
(43) Pub. Date: Mar. 2, 2023

(54) Hand Grip Sleeve for Cooking Oil Spray Can

(71) Applicant: Nancy Wynne Childress, Gilmanton, NH (US)

(72) Inventor: Nancy Wynne Childress, Gilmanton, NH (US)

(21) Appl. No.: 17/411,210

(22) Filed: Aug. 25, 2021

(51) Int. Cl. B65D 83/20; B05B 15/63; B65D 23/10

(52) U.S. Cl. CPC B65D 83/202; B05B 15/63; B65D 23/104; B65D 2525/285; B65D 2525/289

(57) ABSTRACT

The art of this invention is new. The technical disclosures as described will allow a person to have a firm grip on an otherwise slippery can of spray grease. The 2" x 4" x .125 material is a clear silicone sleeve which can stretch and is washable. The product’s company logo is not obscured by the sleeve. The size of grease cans are uniformly 2-¼" in diameter so it can be used with various manufacturers' products. The 2" diameter allows stretching for a tight fit on the 2-¼" diameter can. The 4" height of the piece will allow for increased grip area. No other invention could be found that solves this problem.

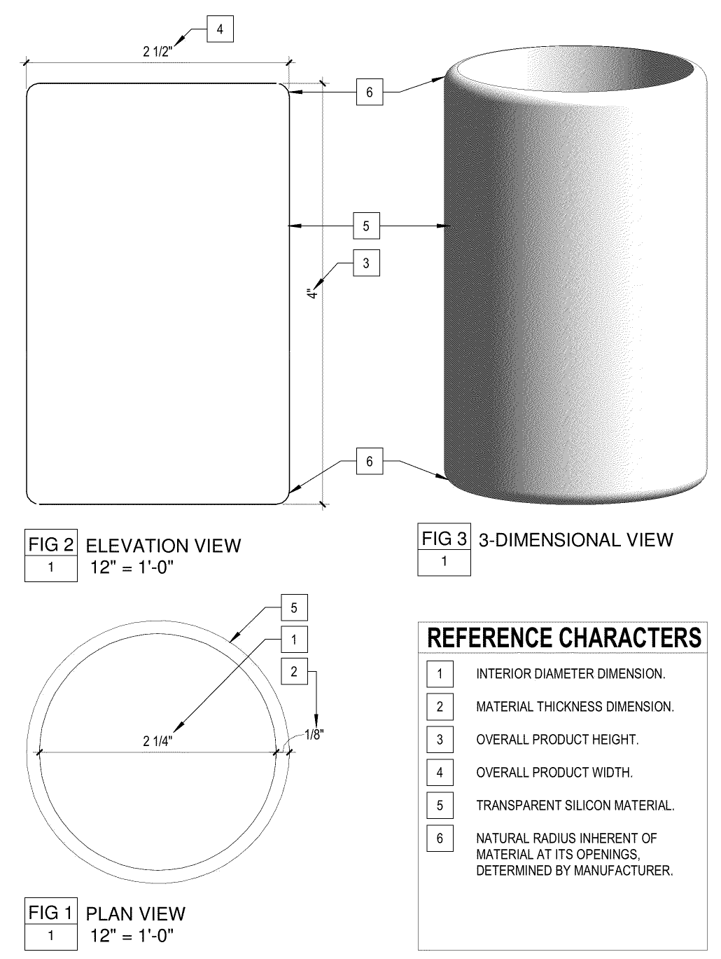

### CROSS REFERENCE TO RELATED APPLICATIONS

Not applicable

### STATEMENT REGARDING FEDERALLY SPONSORED RESEARCH OR DEVELOPMENT:

Not applicable

### REFERENCE TO SEQUENCE LISTING, A TABLE, OR A COMPUTER PROGRAM LISTING COMPACT DISC APPENDIX:

Not applicable

### BACKGROUND OF THE INVENTION

The patent classification is Manufactures and the field is Kitchen Aids. It is a silicone cylindrical sleeve that slides onto a can of spray grease such as “Pam”. The silicone grip allows the holder to have a firm grip on what would otherwise become slippery and difficult to hold while trying to depress the spray button.

### BRIEF SUMMARY OF THE INVENTION

The cylindrical silicone sleeve solves a common problem of losing a grip on a spray can of cooking grease while trying to depress the spray button. The 2" x 4" x .125" silicone sleeve is clear, allowing the spray manufacturer’s design to show through. It is stretchy to provide ease in sliding onto the can either from the top or the bottom. Reusable and washable.

### BRIEF DESCRIPTION OF THE SEVERAL VIEWS OF THE DRAWING

See Abstract FIG. drawing which shows the diameter, height, width and depth of the silicone piece.

### DETAILED DESCRIPTION OF THE INVENTION

The silicone cylindrical grip sleeve can be used by anyone who uses spray grease cans when cooking. It may be particularly helpful with the elderly who may have arthritis. I have not found anything patented or on the market that solves this problem. The clear 2" x 4" x .125 silicone sleeve can be manufactured through a process of Extrusion or Injection Molding, using an Injection Molding machine which is the most common way to manufacture silicone tubing.

The best mode of carrying out the invention would be to have it manufactured in this way and distributed through proper licensing avenues to a supplier or retailer.

### Drawing 1/1

1: Plan View
2: Elevation View
3: Dimension View

### SEQUENCE LISTING

Not applicable

1. Design for a hand grip for a spray grease can container used in cooking, as shown and described.
